(19) United States
(12) Patent Application Publication
(10) Pub. No.: US 2026/0078741 A1
(43) Pub. Date: Mar. 19, 2026

(54) SCALABLE SYSTEM AND ENGINE FOR FORECASTING WIND TURBINE FAILURE

(71) Applicant: Utopus Insights, Inc., Valhalla, NY (US)

(72) Inventor: Xueyin Yu, White Plains, NY (US)

(73) Assignee: Utopus Insights, Inc., Valhalla, NY (US)

(21) Appl. No.: 19/003,876

(22) Filed: Dec. 27, 2024

Related U.S. Application Data
(60) Provisional application No. 63/615,755, filed on Dec. 28, 2023.

(51) Int. Cl. F03D 17/00; G08B 21/18

(52) U.S. Cl. CPC F03D 17/014; G08B 21/187; F05B 2260/84

(57) ABSTRACT

Example systems and methods comprise receiving sensor measurements including time data from one or more wind turbines over time, aligning time domain data of the sensor measurements of a particular wind turbine with a rotation speed of the particular wind turbine, the particular wind turbine being at least one of the one or more wind turbines, transforming the aligned time domain data to obtain a cepstrum data, identifying one or more quefrency components of the cepstrum data that correspond to periodicities of interest, classifying at least one of the one or more quefrency components with future failure of at least one component of the particular wind turbine, and providing an alert to a user based on the classification to alert the user of a predicted failure of the particular wind turbine.

### CROSS-REFERENCE TO RELATED APPLICATION

This application claims priority to U.S. Provisional Patent Application No. 63/615,755, filed on Dec. 28, 2023, and entitled “Gearbox Planet Gear Failure Detection,” which is incorporated in its entirety herein by reference.

### FIELD OF THE INVENTION

Embodiments of the present invention(s) relate generally to forecasting failure of renewable energy assets and, in particular, evaluating models to predict failures of one or more components of wind turbines.

### DESCRIPTION OF RELATED ART

The increasing reliance on wind energy as a sustainable power source necessitates the development of advanced maintenance systems to ensure the reliability and efficiency of wind turbines. Wind turbines operate in harsh and variable environmental conditions, making them susceptible to component failures that can lead to significant downtime and maintenance costs.

Detection and prediction of failure in one or more components of a wind turbine is difficult. Given that detection of a failure of a component of an asset may be difficult to determine, increased accuracy of prediction of future failures compounds problems.

### SUMMARY

An example non-transitory computer-readable medium comprises executable instructions. The executable instructions are executable by one or more processors to perform a method, the method comprising receiving sensor measurements including time data from one or more wind turbines over time, aligning time domain data of the sensor measurements of a particular wind turbine with a rotation speed of the particular wind turbine, the particular wind turbine being at least one of the one or more wind turbines, transforming the aligned time domain data to obtain a cepstrum data, identifying one or more quefrency components of the cepstrum data that correspond to periodicities of interest, classifying at least one of the one or more quefrency components with future failure of at least one component of the particular wind turbine, and providing an alert to a user based on the classification to alert the user of a predicted failure of the particular wind turbine.

The method may further comprise extracting a peak value of the one or more quefrency components, wherein classifying the at least one or more quefrency components of the cepstrum data that correspond to the periodicities of interest comprises classifying the peak value of the at least one or more quefrency components, the peak value corresponding to at least one periodicity of the periodicities of interest indicating a type of fault.

In some embodiments, the method further comprises extracting a root mean square (RMS) value calculated over a specific quefrency component of the one or more quefrency components and related rahmonics, wherein classifying the at least one or more quefrency components of the cepstrum data that correspond to the periodicities of interest comprises classifying the RMS value to quantify energy associated with at least some of the periodicities of interest, the quantified energy indicating a fault.

In various embodiments, the method further comprises extracting a peak value of the one or more quefrency components, extracting a root mean square (RMS) value calculated over a specific quefrency component of the one or more quefrency components and related rahmonics, and determining a crest factor by calculating a ratio of the peak value to the RMS value to identify impulsive events or irregularities in the cepstrum data indicating potential faults, wherein classifying the at least one or more quefrency components of the cepstrum data that correspond to the periodicities of interest comprises classifying the crest factor as an indicator of potential faults.

Aligning the time domain data of the sensor measurements of the particular wind turbine with the rotation speed of the particular wind turbine may comprise angular resampling of the sensor measurements to align the time domain data with the rotation speed of the particular wind turbine. Transforming the aligned time domain data to obtain cepstrum data may comprise applying a Fourier transform to the aligned time domain data to generate transformed data and applying an inverse Fourier transform to the transformed data to generate the cepstrum data. The method may further comprise determining a logarithm of a magnitude of the spectrum after application of the Fourier transform, the transformed data including the logarithm of the magnitude of the spectrum.

In various embodiments, classifying the at least one of the one or more quefrency components with future failure of at least one component of the particular wind turbine comprises applying the one or more quefrency components of the cepstrum data that correspond to the periodicities of interest to a model, the model trained using logistic regression. Further, in some embodiments, some embodiments, the model is validated using 5-fold cross validation to assess generalizability and reduce overfitting. The model may be validated in part by applying a probability threshold to classify a model prediction by the model, the probability threshold maximizing an F-beta score, the F-beta score being a weighted harmonic mean of precision and recall.

An example failure prediction system may comprise at least one processor and memory. The memory may contain instructions executable by the at least one processor to: receive sensor measurements including time data from one or more wind turbines over time, align time domain data of the sensor measurements of a particular wind turbine with a rotation speed of the particular wind turbine, the particular wind turbine being at least one of the one or more wind turbines, transform the aligned time domain data to obtain a cepstrum data, identify one or more quefrency components of the cepstrum data that correspond to periodicities of interest, classify at least one of the one or more quefrency components with future failure of at least one component of the particular wind turbine, and provide an alert to a user based on the classification to alert the user of a predicted failure of the particular wind turbine.

The instructions may be further executable by the at least one processor to: extract a peak value of the one or more quefrency components, wherein classifying the at least one or more quefrency components of the cepstrum data that correspond to the periodicities of interest comprises classifying the peak value of the at least one or more quefrency components, the peak value corresponding to at least one periodicity of the periodicities of interest indicating a type of fault. In some embodiments, the instructions are further executable by the at least one processor to extract a root mean square (RMS) value calculated over a specific quefrency component of the one or more quefrency components and related rahmonics, wherein classifying the at least one or more quefrency components of the cepstrum data that correspond to the periodicities of interest comprises classifying the RMS value to quantify energy associated with at least some of the periodicities of interest, the quantified energy indicating a fault. In various embodiments, the instructions are further executable by the at least one processor to: extract a peak value of the one or more quefrency components, extract a root mean square (RMS) value calculated over a specific quefrency component of the one or more quefrency components and related rahmonics, and determine a crest factor by calculating a ratio of the peak value to the RMS value to identify impulsive events or irregularities in the cepstrum data indicating potential faults, wherein classifying the at least one or more quefrency components of the cepstrum data that correspond to the periodicities of interest comprises classifying the crest factor as an indicator of potential faults.

The instructions being executable by the at least one processor to align the time domain data of the sensor measurements of the particular wind turbine with the rotation speed of the particular wind turbine may comprise the instructions being further executable by the at least one processor to angular resample the sensor measurements to align the time domain data with the rotation speed of the particular wind turbine.

In some embodiments, the instructions being executable by the at least one processor to transform the aligned time domain data to obtain cepstrum data comprises the instructions being further executable by the at least one processor to apply a Fourier transform to the aligned time domain data to generate transformed data and apply an inverse Fourier transform to the transformed data to generate the cepstrum data. The instructions may be further executable by the at least one processor to further determine a logarithm of a magnitude of the spectrum after application of the Fourier transform, the transformed data including the logarithm of the magnitude of the spectrum.

In various embodiments, the instructions being executable by the at least one processor to classify the at least one of the one or more quefrency components with future failure of at least one component of the particular wind turbine comprises the instructions being further executable by the at least one processor to apply the one or more quefrency components of the cepstrum data that correspond to the periodicities of interest to a model, the model trained using logistic regression. The model may be validated using 5-fold cross validation to assess generalizability and reduce overfitting. The model may be validated in part by applying a probability threshold to classify a model prediction by the model, the probability threshold maximizing a F-beta score, the F-beta score being a weighted harmonic mean of precision and recall.

An example method comprises receiving sensor measurements including time data from one or more wind turbines over time, aligning time domain data of the sensor measurements of a particular wind turbine with a rotation speed of the particular wind turbine, the particular wind turbine being at least one of the one or more wind turbines, transforming the aligned time domain data to obtain a cepstrum data, identifying one or more quefrency components of the cepstrum data that correspond to periodicities of interest, classifying at least one of the one or more quefrency components with future failure of at least one component of the particular wind turbine, and providing an alert to a user based on the classification to alert the user of a predicted failure of the particular wind turbine.

### BRIEF DESCRIPTION OF THE DRAWINGS

FIG. 1 depicts a diagram of an example electrical network in some embodiments.

FIG. 2 depicts components that often produce failures of wind turbines.

FIG. 3 depicts an example planetary stage in gearbox.

FIG. 4 depicts a common problem of detecting possible failure of one or more components of a wind farm.

FIG. 5 depicts traditional failure prediction approaches of main shaft bearing failure in wind turbines as well as challenges.

FIG. 6 is an example failure prediction system in some embodiments.

FIG. 7 is a flowchart for predictive maintenance using cepstral analysis in some embodiments.

FIG. 8 is a graph showing an order spectrum of a turbine fifteen days before gear failure.

FIG. 9 depicts the corresponding cepstrum of the order spectrum depicted in FIG. 8, where the relevant quefrency components and their rahmonics are highlighted.

FIG. 10 depicts a subset of features extracted up to 30 days before failure in one example.

FIG. 11 depicts an example of hierarchical clustering in some embodiments.

FIG. 12 is a flowchart for the model selection pipeline in some embodiments.

FIG. 13 is an example of a confirmed alert in an application from the PS2 gearset monitor using a process described herein.

FIG. 14 is another example of a PS2 gearset failure detected by the monitor using a process described herein.

FIG. 15 depicts a block diagram of an example computer system server according to some embodiments.

### DETAILED DESCRIPTION

In the renewable energy industry, it is crucial to accurately forecast component failures with as much lead time as possible. Given that these models predict failure of assets involved in energy generation for industry as well as populations, these prior art systems impact productivity, infrastructure, legacy electrical systems, and, in some cases, the lives of people being served (e.g., in a hospital receiving critical care or the elderly, particularly in a heat wave or cold conditions).

Some embodiments described herein utilize machine learning algorithms to build a sophisticated forecasting model based on multi-variate sensor data to forecast component failures. In some embodiments, a system processes the time waveform sensor data collected from both faulty and normal operating turbines, and converts the sensor data into spectrum and cepstrum domains. By utilizing cepstral analysis, the system extracts critical features that are then used to train machine learning models for fault detection and prediction.

Various embodiments described herein overcome limitations of the prior art and may provide scalability, proactive warnings, and/or computational efficiency while providing improved accuracy with a centralized system for performing data analysis (e.g., feature generation), model generation, model selection, model training, model testing, prediction, and alerts for failure prediction.

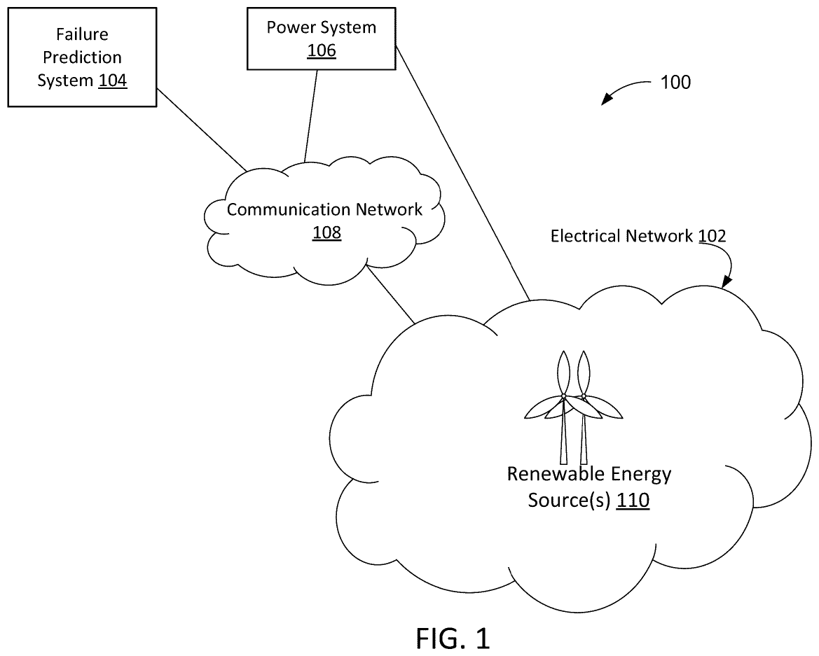

FIG. 1 depicts a diagram 100 of an example electrical network in some embodiments. FIG. 1 includes a network 102 (which may be part of an electrical network for distribution of electrical power), a failure prediction system 104, and a power system 106 in communication over a communication network 108. The network 102 includes any number of renewable energy sources 110 as well as transmission lines, substations, and transformers. The network 102 may include any number of electrical assets including protective assets (e.g., relays or other circuits to protect one or more assets), transmission assets (e.g., lines, or devices for delivering or receiving power), and/or loads (e.g., residential houses, commercial businesses, and/or the like).

Components of the network 102 such as the renewable energy source(s) 110, the transmission lines, substations, and/or transformers may inject energy or power (or assist in the injection of energy or power) into the network 102. Each component of the network 102 may be represented by any number of nodes in a network representation of the electrical network. Renewable energy sources 110 in this example may include any number of wind turbines. in some embodiments, the renewable energy sources 110 may be or include solar panels and/or other forms of “green” or renewable energy sources. The network 102 may include a wide electrical network grid (e.g., with 40,000 assets or more). Each electrical asset of the network 100 may represent one or more elements of their respective assets.

In some embodiments, the failure prediction system 104 may be configured to receive sensor data from any number of sensors of any number of wind turbines and/or wind turbine components. The failure prediction system 104 may subsequently generate any number of models to predict failures of any number of components. Different models for the same component(s) may be generated based on a common set of metrics.

Each model may be evaluated to determine accuracy of the model and the length of time prior to predicted failure at the desired level of accuracy. As such, the failure prediction system 104 may be used to generate and evaluate multiple models using the same historical sensor data but each with different lengths of time prior to predicted failure in order to identify at least one model with an acceptable accuracy at an acceptable prediction time before component failure is expected to occur.

In some embodiments, communication network 108 represents one or more computer networks (e.g., LAN, WAN, and/or the like). Communication network 108 may provide communication between any of the failure prediction system 104, the power system 106, and/or the network 102. In some implementations, communication network 108 comprises computer devices, routers, cables, and/or other network topologies. In some embodiments, communication network 108 may be wired and/or wireless. In various embodiments, communication network 108 may comprise the Internet, one or more networks that may be public, private, IP-based, non-IP based, and so forth.

The failure prediction system 104 may include any number of digital devices configured to forecast component failure of any number of components and/or generators (e.g., wind turbine or solar power generator) of the renewable energy sources 110. The failure prediction system 104 receives sensor data from any number of wind turbines and/or wind turbine components, generates desired features from the sensor data as discussed herein, and selects, trains, tests, and applies failure prediction models for components and groups of components of renewable energy assets (e.g., renewable energy source(s) 110).

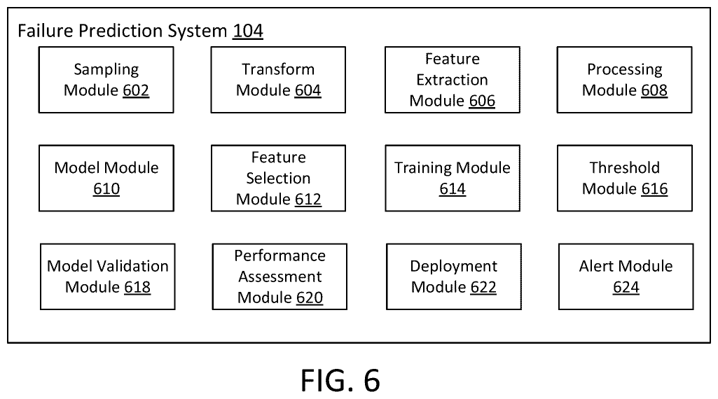

In various embodiments, the failure prediction system 104 utilizes a centralized system to receive sensor data (e.g., from any number of wind turbines and any number of wind turbine farms, even those remote from each other), generate feature data from the sensor data, train models, apply models to new sensor information, and provide alerts and/or dashboards for all or subsets of the wind turbines. This process and architecture may allow for a reduction of computational burden, allow for significant scalability, and improve the time to generate failure prediction models. It will be appreciated that if there are numerous models for numerous components of any number of renewable energy assets, the generation of failure prediction models in a timely manner (using recent data to improve accuracy) in a scalable system may be critical. The failure prediction system 104 is further discussed in FIG. 6.

The power system 106 may include any number of digital devices configured to control distribution and/or transmission of energy. The power system 106 may, in one example, be controlled by a power company, utility, and/or the like. A digital device is any device with at least one processor and memory. Examples of systems, environments, and/or configurations that may be suitable for use with the system include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

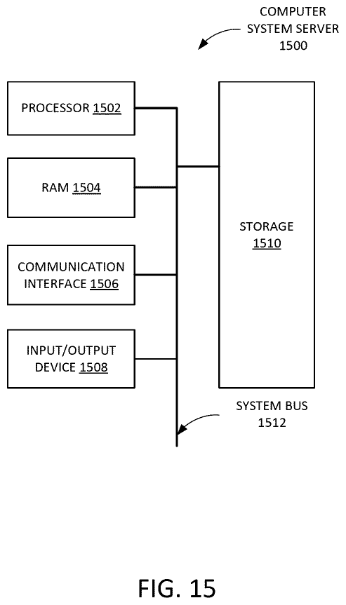

A computer system may be described in the general context of computer system executable instructions, such as program modules, being executed by a computer system. Generally, program modules may include routines, programs, objects, components, logic, data structures, and so on that perform particular tasks or implement particular abstract data types. A digital device, such as a computer system, is further described with regard to FIG. 15.

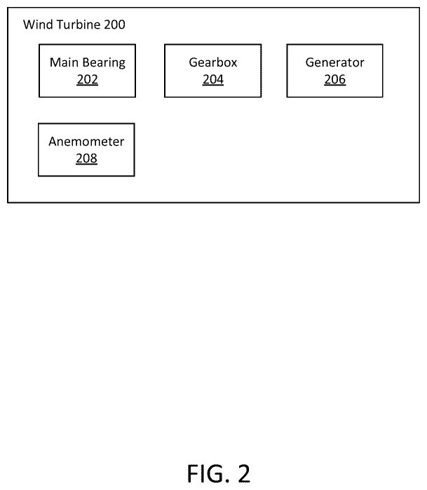

FIG. 2 depicts components that often produce failures of wind turbines 200. Failures in wind turbines often occur as a result of failures in a main bearing 202, gearbox 204, generator 206, or anemometer 208.

Various embodiments regarding a wind turbine described herein may identify a potential failure of a main bearing 202, gearbox 204, generator 206, or anemometer 208 of one or more wind turbines. Although many bearings may be utilized in a wind turbine (e.g., yaw and pitch bearings), the main shaft and gearbox of the wind turbine tend to be the most problematic. For example, a main bearing 202 may fail due to high thrust load or may fail due to inadequate lubricant film generation. Trends in the redesign of a main shaft and/or gearbox 204 of a single wind turbine have been driven by unexpected failures in these units. The unplanned replacement of main-shaft bearing 202 can cost operators up to $450,000 and have an obvious impact on financial performance.

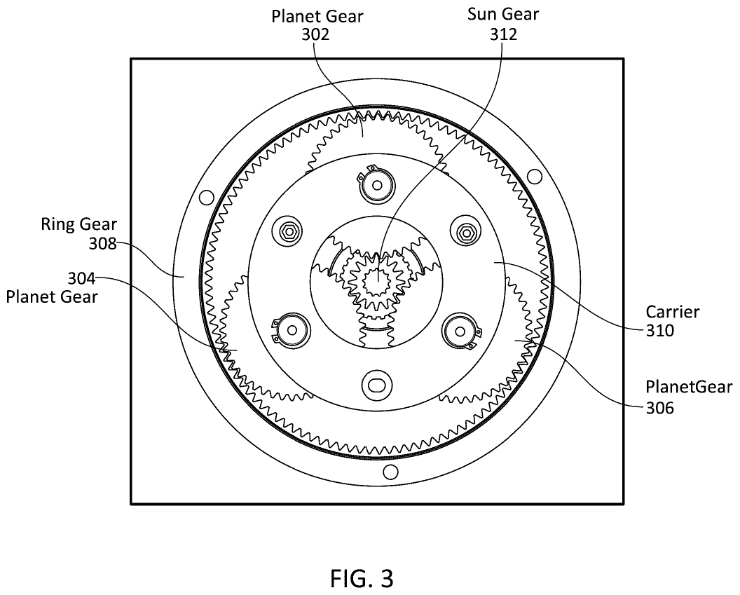

The gearbox 204 itself is a sophisticated system composed of multiple stages, including one or multiple planetary stages. The planetary stage features gears that interact simultaneously. This complexity complicates the isolation and identification of specific faults, as signals from different gears can overlap and interfere with each other. FIG. 3 depicts an example of a planetary stage within a gearbox. The planetary stage in this example includes planet gears 302, 304, and 306, as well as ring gear 308, carrier 310, and a sun gear 312. In this example, the sun gear 312 is the central gear around which the other gears (planets) revolve. The sun gear 312 receives the input torque and rotational speed from the low-speed shaft connected to the rotor of the wind turbine. The sun gear 312 transfers motion and power to the planet gears that surround it.

The planet gears 302, 304, and 306 orbit around the sun gear 312 and engage with both the sun gear 312 and the ring gear 308. The planet gears 302, 304, and 306 increase the gearbox's torque capacity and reduce its speed by distributing the load across multiple points, which increases efficiency and durability. The planet gears 302, 304, and 306 are mounted on a rotating carrier 310 that holds them in position as they rotate and orbit.

The ring gear 308 is a large gear that encircles the planet gears 302, 304, and 306. The ring gear 308 typically has internal teeth that mesh with the external teeth of the planet gears 302, 304, and 306. In many designs, the ring gear 308 is stationary and provides a reaction torque against which the planet gears 302, 304, and 306 can drive. In some configurations, the ring gear 308 may also rotate, providing additional output or functioning as part of a compound planetary stage.

The carrier 310 acts as the frame for the planet gears 302, 304, and 306, holding them in their relative positions and allowing them to orbit around the sun gear 312. The carrier 310 connects to the output shaft of the gearbox. As the planet gears 302, 304, and 306 rotate and orbit due to the input from the sun gear 312, the carrier 310 collects this rotational motion and transmits the combined output torque to the gearbox's output shaft.

The carrier's movement is important for transferring the modified speed and torque to the generator, effectively stepping up the rotational speed from the slow-moving turbine blades to the fast-spinning generator needed to produce electricity efficiently.

By transforming the time waveform data into the quefrency domain, cepstral analysis facilitates the isolation and identification of specific gear faults despite the gearbox's complexity. This method enhances the detection of periodicities related to gear meshing frequencies and their harmonics. A wind turbine has many potential components that may fail. Different sensors may provide different readings for one or more different components or combinations of components. Given the number of wind turbines in a wind farm, the amount of data to be assessed may be untenable using prior art methods. For example, data analytics systems of the prior art do not scale, sensors provide too much data to be assessed by the prior art systems, and there is a lack of computational capacity in prior art systems to effectively assess data from wind farms in a time sensitive manner. As a result, prior art systems are reactive to existing failures rather than proactively providing reports or warnings of potential future failure of one or more components.

Gearbox 204 failures are one of the largest sources of unplanned maintenance costs. Gearbox 204 failures can be caused by design issues, manufacturing defects, lubricant deficiencies, excessive standstill time, high loading, and other reasons. There may be many different modes of gearbox 204 failure, and as such, it may be important to identify the type of failure mode in order to address the failure. One mode is micropitting which occurs when lubricant film between contacting surfaces in a gearbox 204 is not thick enough. Macropitting occurs when contact stress in a gear or breaking exceeds the fatigue strength of the material. Bending fatigue is a failure mode that affects gear teeth and axial cracking, which may occur in the bearings of a gearbox; the cracks develop in the axial direction, perpendicular to the direction of rolling.

The generator 206 typically converts the wind energy to electrical energy. Failures often occur in bearings, stator, rotor, or the like which can lead to inconsistent voltage to total failure. Generator 206 failure may be difficult to detect as a result of inconsistent weather, lack of motion, and/or partial failure of the anemometer 208.

The anemometer 208 uses moving parts as sensors. Anemometers 208 often include “cups” for wind speed measurements and a wind vane that uses a “vane tail” for measuring vector change, or wind direction. Freezing weather has caused the “cups” and “vane tail” to lock. If an anemometer 208 under-reports wind speed because of a partial failure, there is an increase in rotor acceleration that indicates a large amount of wind energy is not converted into electrical engineering. Rolling resistance in an anemometer 208 bearings typically increase over time until they seize. Further, if the anemometer 208 is not accurate, the wind turbine will not control blade pitch and rotor speed as needed. Poor or inaccurate measurements by the anemometer 208 will lead to incorrect adjustments and increased fatigue.

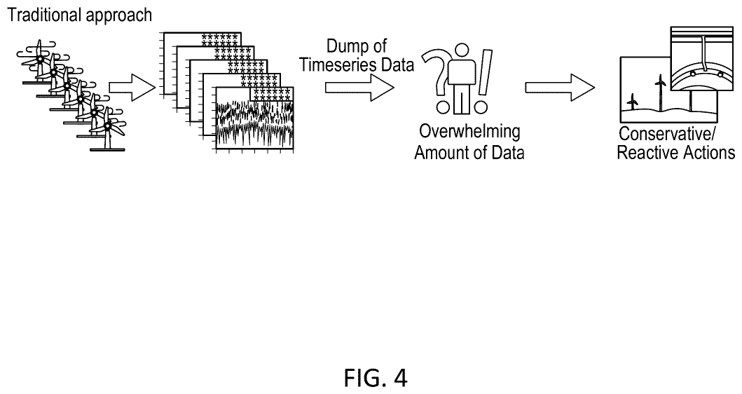

FIG. 4 depicts a common problem of detecting possible failure of one or more components of a wind farm. As shown in FIG. 4, there may be any number of wind turbines in a wind farm. Sensors of each wind turbine in a wind farm may generate its own data. As a result, there is a dump of timeseries data which is overwhelming for prior art systems and prior art methods of assessment. As illustrated, monitoring hundreds of assets with hundreds of sensor inputs is time-consuming and overwhelming for operators to test. As a further consequence, evaluating different models for different components to predict failure in those components becomes difficult and accuracy can suffer as the desired time to predict component failure increases.

Existing prior art systems receive too much timeseries data to be effectively assessed in a scalable and/or computationally efficient manner. As a result, there is a conservative and or reactive response to component and wind turbine failure. In other words, action is typically taken well after failure is detected or when failure is both immanent and unmistakable.

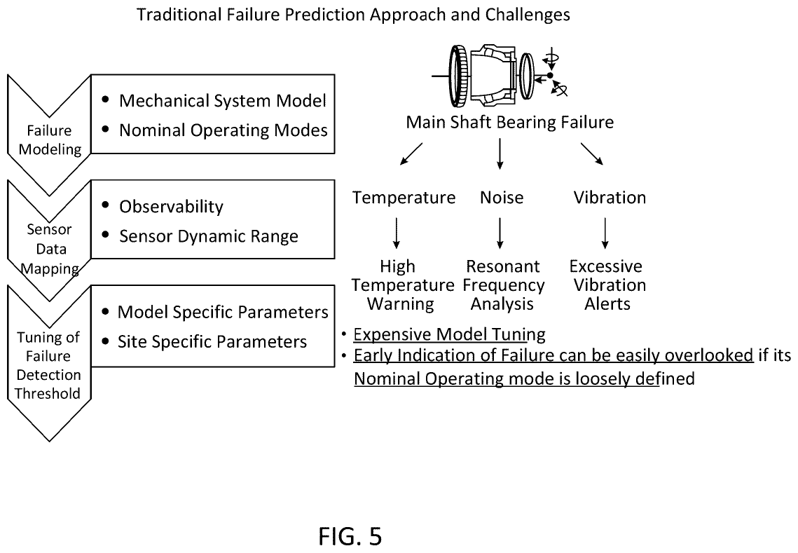

FIG. 5 depicts traditional failure prediction approaches of main shaft bearing failure in wind turbines as well as challenges. In this example, main shaft bearing failure may be caused by any number of components. For prior art analysis, challenges include identifying the correct mechanical systems model and nominal operating modes of that mechanical system model.

Prior art approaches may also fail due to incorrect sensor data mapping. Mapping of sensor data may be based on observability and take into account sensor dynamic range. In this example of the main shaft bearing failure, sensor data regarding temperature, noise, and/or vibration may be taken into account.

Prior art systems often fail to tune a failure detection threshold for a sensor reading. Prior art systems typically must identify model specific parameters and site-specific parameters. In this case, the temperature sensor data may indicate a high temperature warning relative to some high temperature threshold. The noise data may be utilized for resonant frequency analysis to detect residents within a component or device. The vibration data may be assessed to determine excessive vibration relative to some vibration threshold.

Further early indication of failures in temperature, noise, vibration, or other failures, can be easily overlooked if it's nominal operating mode is loosely defined by the prior art system.

FIG. 6 is an example failure prediction system 104 in some embodiments. The failure prediction system 104 in this example includes a sampling module 602, a transform module 604, a feature extraction module 606, a processing module 608, a model module 610, a feature selection module 612, a training module 614, a model validation module 618, a performance assessment module 620, a deployment module 622, and an alert module 624.

The failure prediction system 104 may receive measurement data from any number of turbines at any number of sites (e.g., any number of wind turbine farms). In some embodiments, the failure prediction system 104 may be coupled to the Internet (e.g., the communication network 108) and receive sensor measurements from any number of turbines (e.g., via electrical grid operators or the like).

The sampling module 602 may receive measurements from any number of turbines (e.g., healthy turbines, faulty turbines, or both). In some embodiments, the sampling module 602 receives and/or pulls measurement data (e.g., sensor data) from any number of wind turbines, wind turbine sites, and/or power systems (e.g., such as electrical power operators).

In various embodiments, the sampling module 602 may perform angular resampling on the collected measurements. For example, the sampling module 602 may perform angular resampling on the collected data to align the time-domain data with the particular turbine's rotational speed.

The transform module 604 may transform the resampled time waveform (e.g., received from the sampling module 602) to obtain the order cepstrum. The transform module 604 may utilize any transformation and/or inverse transformation to obtain the order cepstrum. In one example, the transform module 604 applies a Fourier transform to the received data from the sampling module 602 and applies an inverse Fourier transform to obtain the order cepstrum. In some embodiments, the transform module 604 applies the Fourier transform, computes a logarithm of the magnitude, and applies an inverse Fourier transform to convert the data to the cepstrum domain.

The feature extraction module 606 may identify specific quefrency components that correspond to periodicities of interest (e.g., periodicities that may be associated with performance, failure, and/or health of a wind turbine component). The quefrency components may be or include, for example, a peak value of the quefrency, a root mean square (RMS) value, and/or crest factor which are further discussed herein. Where quefrency components such as the peak value, RMS value, and crest factor are discussed herein, it will be appreciated that any components (or combinations thereof) related to health of performance from the cepstrum domain may be extracted.

The processing module 608 may optionally scale input features. In one example, the processing module 608 may scale input features according to wind turbine component manufacturer and/or wind turbine component type.

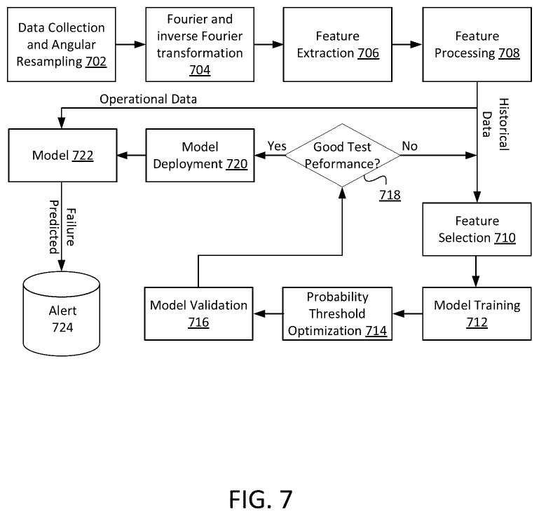

The model module 610 may be or include any number of models that are generated, tested, and/or validated (e.g., using the process described with regard to FIG. 7). The model may be or include a random forest (RF), support vector machine (SVM), neural network, a/or logistic regression. It will be appreciated that the model may be a combination of models such as a combination of trained models that are weighted and scored for the best result based on performance for different wind turbines, components, and/or the like.

The feature selection module 612 may select any number of features from the data received from the feature extraction module 606 or the processing module 608. The feature selection module 612 may, for example, selects features such as, but not limited to, principal component analysis (PCA), recursive feature elimination (RFE), and/or mutual information.

The training module 614 may train a model generated from at least the selected features of the selection module 612. In some embodiments, the training module 614 may train one or more models based on historical data received from a wind turbine, wind turbine component, and/or the like. For example, the model may be trained using historical data that is sampled, transformed into the cepstrum domain, features extracted, and optionally processed as discussed herein.

The threshold module 616 may determine a threshold to be used in assessing model performance. In one example, the threshold module 616 may calculate an F-beta score for various probability thresholds. The threshold module 616 may identify the threshold that maximizes the F-beta score. While an F-beta score is given as an example for determining a threshold, it will be appreciated that any threshold may be used and/or selected (e.g., based on testing and/or performance).

The model validation module 618 may validate the trained model using the threshold from the threshold module 616 in some embodiments. In one example, the model with the optimized probability threshold may be designated as the reference model and may be validated against a separate dataset that was not used during training or cross-validation

The performance assessment module 620 may assess the validated model using historical data from one or more wind turbines and/or wind turbine components. For example, historical data may be received and processed in steps 702-706 (and optionally step 708) before being provided to the validated model. The performance assessment module 620 may determine the accuracy of the validated model using the historical data and comparing the results from the validated model from known data (e.g., comparing the predictions to whether the wind turbine components are failing, going to fail, and/or are healthy).

The deployment module 622 may deploy the validated model assuming model performance is sufficiently accurate (e.g., based on the assessment by the performance assessment module 620). Once the model is deployed, the model may receive new sensor data (e.g., via in steps 702-706 (and optionally step 708)). The model may be deployed in a centralized platform on a network (e.g., on the Internet) or one or more internal platforms that support power networks.

The model may then make predictions based on the received operational data. In various embodiments, if the model predicts failure, unhealthy operational performance, or states of concern, the alert module 614 may generate an alert. In some embodiments, the alert module 614 provides a text, alert on a digital device, phone call, email and/or the like. In some embodiments, the alert module 614 provides an alert on a dashboard that highlights states of concern, failures and/or the like.

It will be appreciated that the alert module 614 may provide a variety of different alerts, including alerts for predicted failure, alerts for unknown operational health (e.g., the analysis from the model is inconclusive), alerts for being in a threshold that is associated with possible failure, and/or operational data is not expected (e.g., operational data is corrupted).

In some embodiments, a user (e.g., network operator) may provide or influence thresholds so that each electrical network can establish its sensitivity to risk, failure, and/the like. For example, one entity may have little tolerance for risk and may set the alert module 614 and/or the threshold of the threshold module 616 to send an alert for any unhealthy performance. Another entity may utilize a similar system, but set the alert module 614 and/or the threshold module 616 to only send an alert if an unhealthy condition is persistent over a period of time, is changing to be more unhealthy over a period of time, or must reach higher thresholds (e.g., as compared to the first entity).

In various embodiments, a variety of unrelated power operators and/or users may utilize a platform using the failure prediction system 104. The failure prediction system 104 may utilize the same or different models for different users. In some embodiments, a model may be trained on a variety of different data from different wind turbines at different sites operated by different, unrelated users. In some embodiments, one or more models may be trained for a particular operator and specific users using only those wind turbines owned or operated by that particular operator and/or specific users.

It will be appreciated that a model trained and utilized using data as processed (e.g., features extracted) herein may be utilized to monitor health and predict failures in real time as data from wind turbine sensors is captured. This real time process can assist in avoiding costly, expensive, and potentially life threatening conditions related to power failure or emergency maintenance in unsafe conditions.

It will be appreciated that the use of cepstral analysis inherently improves noise robustness by transforming the signal into the quefrency domain, where periodicities related to mechanical faults become more pronounced. This may make the system more effective at detecting faults even in noisy environments, which may be crucial for wind turbines operating in harsh and variable conditions.

Further, by leveraging advanced machine learning techniques, the system ensures the development of robust and reliable predictive models. The incorporation of sophisticated feature extraction and selection processes described herein further boosts the model's accuracy by concentrating on the most relevant and informative features. This targeted approach may not only improve fault detection but may also enhance the overall prediction capabilities, leading to more effective and timely maintenance interventions.

In various embodiments, incorporating explainable AI techniques ensures that the decision-making process of the machine learning models is transparent and understandable. This helps in gaining trust of operators and maintenance teams, as they can see and understand the rationale behind the predictions and detected faults.

In some embodiments, the system can seamlessly integrate with IoT devices to continuously collect data from wind turbines. By leveraging big data analytics, it can be scaled to process large volumes of information and enable predictive model development, validation, and monitoring for various wind turbine components across a wide range of populations. Scalability may provide effective cost savings and enhances overall operational efficiency.

It will be appreciated that some embodiments of the system described herein is designed to be applicable to offshore wind turbines, which operate in even more challenging environments. The noise robustness and advanced predictive capabilities make it particularly suitable for these conditions, helping to reduce maintenance costs and downtime for offshore installations.

One or more enhancements discussed herein may enable a comprehensive and cutting-edge solution for predictive maintenance in wind turbines, addressing key challenges and improving overall efficiency and reliability.

In this description, the term “module” refers to computational logic for providing the specified functionality. A module can be implemented in hardware, firmware, and/or software. Where the modules described herein are implemented as software, the module can be implemented as a standalone program but can also be implemented through other means, for example, as part of a larger program, as any number of separate programs, or as one or more statically or dynamically linked libraries. It will be understood that the named modules described herein represent one embodiment, and other embodiments may include other modules. In addition, other embodiments may lack modules described herein and/or distribute the described functionality among the modules in a different manner. Additionally, the functionalities attributed to more than one module can be incorporated into a single module. In an embodiment where the modules are implemented by software, they are stored on a computer-readable persistent storage device (e.g., hard disk), loaded into the memory, and executed by one or more processors as described above in connection with FIG. 15. Alternatively, hardware or software modules may be stored elsewhere within a computing system.

FIG. 7 is a flowchart for predictive maintenance using cepstral analysis in some embodiments. In step 702, the sampling module 602 may collect sensor data. In one example, the sampling module 602 collects component time waveform (TWF) and tachometer measurements from any number of turbines (e.g., both faulty and healthy turbines). In some embodiments, the sampling module 602 collects the TWF and tachometer measurements from both faulty and healthy turbines to ensure a diverse dataset for machine learning modeling. Sensor data may be provided from sensors in the wind turbine, SCADA systems, and/or from any other source(s).

In some embodiments, the sampling module 602 performs angular resampling on the collected data to align the time-domain data with the turbine's rotational speed. For example, the sampling module 602 may receive TWF and tachometer measurements from a particular turbine. The sampling module 602 may perform angular resampling on the collected data to align the time-domain data with that particular turbine's rotational speed. In various embodiments, aligning the time-domain data with that particular turbine's rotational speed ensures the analysis accurately reflects the mechanical behavior of the components under varying operational conditions.

In step 704, the transform module 604 transforms the resampled time waveform. Subsequently, the transform module 604 may applies an inverse transformation to obtain the cepstrum (e.g., order cepstrum). In one example, the transform module 604 may apply a Fourier transformation to the resampled time waveform and then an inverse Fourier transformation to transform the resampled time waveform.

A cepstrum is a mathematical transformation of a signal that allows for the analysis of its frequency content, particularly when dealing with signals that exhibit periodic or quasi-periodic characteristics. In some embodiments, the transform module 604 performs a Fourier transform on the resampled time waveform and computes a logarithm of the magnitude of the spectrum. The logarithm may highlight differences in signal energy across frequencies and makes it easier to detect periodic patterns in the spectrum. The transform module 604 may then apply an inverse Fourier transform to the log spectrum. The resulting domain is the cepstral domain.

The order cepstrum is a type of cepstral representation that modifies the standard cepstrum by introducing a parameter (e.g., a) which controls the weighting or transformation of the logarithm in the cepstral computation. This process may assist to detect faults in rotating machinery by analyzing harmonics and modulation effects. Weighting may be selected based on historical information, the significance of the result to indicate harmonics and/or modulation effects, based on a particular wind turbine farm, based on the particular wind turbine, based on the model of gearbox, type of gearbox, and/or the like (e.g., any or all of these items in any combination).

In various embodiments, the order cepstrum may be particularly helpful because it transforms the signal into the quefrency domain, where periodicities related to mechanical faults become more pronounced and easier to detect. This may make it highly effective for identifying subtle and early-stage faults that might be missed in the time or frequency domains. A quefrequency is a “time” variable in the cepstral domain which is analogous to frequency in the spectrum domain.

In step 706, the feature extraction module 606 identifies specific quefrency components that correspond to the periodicities of interest. In one example, the feature extraction module 606 extracts relevant features from the order cepstrum that are indicative of potential faults. These features can include (but are not limited to) peak value of the quefrency, root mean square (RMS) value, and crest factor. The peak value of the quefrency in the cepstrum may correspond to periodicities in the signal and can indicate specific types of faults. The RMS value may be calculated over a specific quefrency component and its rahmonics, to quantify the energy associated with periodicities in the signal. Rahmonics are peaks in the cepstrum that correspond to periodicities in the spectrum. The crest factor is the ratio of the peak value to the RMS value calculated over its quefrency component and rahmonics. This metric may assist to identify the presence of impulsive events or irregularities in the signal, providing an indication of potential faults.

In step 708, the process module 608 may optionally scale input features. In one example, the process module 608 may scale input features according to wind turbine component manufacturer and type to standardize the data for analysis. Scaling input features may ensure that the features are comparable across different turbines and operational conditions.

In step 710, the feature selection module 612 may optionally perform feature selection to improve model performance, reduce overfitting, and enhance interpretability by focusing on the most relevant data. The feature selection module 612 may perform one or more different techniques for feature selection. In some embodiments, the feature selection module 612 applies for feature selection, such as principal component analysis (PCA), recursive feature elimination (RFE), and mutual information.

In some embodiments, the feature selection module 612 performs a two-step approach for feature selection. First, the feature selection module 612 may apply hierarchical clustering to eliminate features that are highly linearly correlated, thereby reducing redundancy. Next, the feature selection module 612 may apply the sklearn's SelectKBest method to identify the most important features based on their statistical significance.

In step 712, a model is trained. Different machine learning algorithms can be used for modeling, training, and/or validating failure prediction. The logistic regression may be used, in some embodiments, due to its robustness, case of implementation, and ability to convert failure prediction into a binary classification problem using probability threshold. In various embodiments, the LR is combined with a 5-fold cross-validation (CV) technique to ensure robust and reliable performance. Cross-validation may assist in assessing the model's generalizability and reduce (or prevent) overfitting.

In step 714, the threshold module 616 determines a probability threshold. In some embodiments, the probability threshold is the value above which the model classifies a prediction as positive. By adjusting the probability threshold, trade-off between recall and precision can be controlled.

In various embodiments, the threshold module 616 may calculate F-beta score for various probability thresholds. The threshold that maximizes the F-beta score may be selected as the optimal threshold. By optimizing the F-beta score, the model may effectively detect true positives (recall) while minimizing false positives (precision). This balance may avoid overwhelming the system with false alarms while still identifying potential faults.

In step 716, the model validation module 618 validates a model. The model with the optimized probability threshold may be designated as the reference model and may be validated against a separate dataset that was not used during training or cross-validation. This step provides an unbiased evaluation of the model's performance, in order to support adaptability to changes in the operational environment and continue to deliver reliable predictions in real-world scenarios.

In step 718, the performance assessment module 620 assesses the validated model using historical data from one or more wind turbines and/or wind turbine components. Historical data may be received and processed in steps 702-706 (and optionally step 708) before being provided to the validated model. The performance assessment module 620 may determine the accuracy of the validated model using the historical data and comparing the results from the validated model from known data (e.g., comparing the predictions to whether the wind turbine components are failing, going to fail, and/or are healthy).

For example, the sampling module 602 may receive historical sensor data (e.g., sensor data taken at a time where performance and/or failure of a wind turbine component that provided the sensor data is known) from a turbine. Subsequently, the sampling module 602 may perform angular resampling on the received historical sensor data to align the time-domain data with the particular turbine's rotational speed to generate sampled data, the transform module 604 may transform the sampled data using Fourier transform, the transform module 604 may convert the transformed data into the cepstrum domain using an inverse Fourier transform, the feature extraction module 606 may extract features from the cepstrum domain, the processing module 608 may optional scale input features, then then the model may receive the output from the processing module 608 for failure (or health) prediction. The performance assessment module 620 may then assess the prediction against known truth to determine model performance.

In step 720, the deployment module 622 deploys the validated model. Once the model validation module 618 determines that the model demonstrates acceptable testing performance, the model can be registered and deployed for operational use. This involves processing real-time operational data through the same data transformation process to predict upcoming failures. If the model's performance is not satisfactory, the model may be retrained by experimenting with different features or machine learning methodologies to continuously enhance accuracy and reliability.

In step 722, the model may receive operational data for analysis. For example, once a model has been validated and deployed (e.g., using historical data), the sampling module 602 may receive sensor data from a turbine, the sampling module 602 may perform angular resampling on the received sensor data to align the time-domain data with the particular turbine's rotational speed to generate sampled data, the transform module 604 may transform the sampled data using Fourier transform, the transform module 604 may convert the transformed data into the cepstrum domain using an inverse Fourier transform, the feature extraction module 606 may extract features from the cepstrum domain, the processing module 608 may optional scale input features, then then the model may receive the output from the processing module 608 for failure (or health) prediction. The model may compare the analysis to the operational threshold to categorize failure and the alert module 624 may, in step 724, provide an alert upon the prediction of a failure based on the model's prediction.

The importance of this invention lies in its ability to significantly enhance the predictive maintenance capabilities of wind turbines with explainable features associated with faults. This method is versatile enough to detect failures in any rotating components within wind turbines. Furthermore, it is highly scalable, capable of monitoring a large number of wind turbines both onshore and offshore, ensuring wide-ranging applicability.

It will be appreciated that the process depicted in FIG. 7 may be applied to gearbox failures, for example. As discussed herein, the planetary gearbox is a sophisticated system with multiple gears interacting simultaneously. This complexity complicates the isolation and identification of specific faults, as signals from different gears can overlap and interfere with each other. Cepstral analysis (generated by transforming the time waveform data into the quefrency domain as discussed herein) facilitates the isolation and identification of specific gear faults despite the gearbox's complexity. This method enhances the detection of periodicities related to gear meshing frequencies and their harmonics.

Wind turbines operate in harsh environments characterized by significant noise and vibration. These external factors can obscure the subtle signals associated with early-stage gear faults, complicating accurate detection. Cepstral analysis enhances noise robustness by filtering out irrelevant noise and focusing on significant fault-related features, thereby improving the system's effectiveness in detecting faults even in noisy environments. Furthermore, the application of logistic regression (e.g., as discussed herein) with cross-validation may ensure that the predictive models are robust and generalize well to various operating environments and conditions.

Further, in the planetary stage, gears are often enclosed and located deep within the gearbox, leading to signal attenuation where fault-related vibrations are dampened before reaching the sensors, thus reducing the clarity of diagnostic signals. The system's capability to extract and analyze critical features from the order cepstrum aids in detecting fault-related vibrations even when attenuated, thereby enhancing the clarity of diagnostic signals.

While FIG. 7 addresses a particular types of failure, it will be appreciated that the process may apply to many different mechanical components or subcomponents. For example, systems and methods described herein may apply to generator bearings and main bearings.

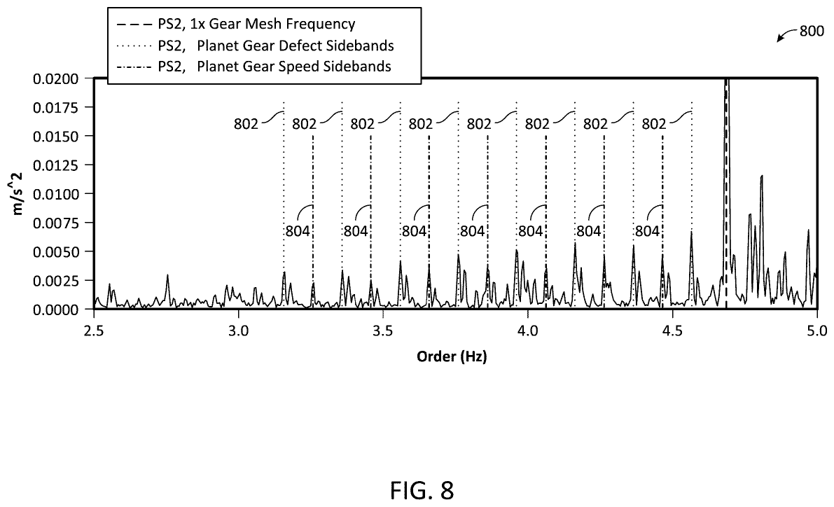

FIG. 8 is a graph showing an order spectrum 800 of a turbine fifteen days before gear failure. Graph 8 depicts an order spectrum of a turbine with PS2 planet gear failure. The sidebands around the planetary tooth mesh frequency (1x Gear Mesh Frequency), with the spacing of planetary defect frequencies, indicate the presence of a planet gear fault (highlighted in lines 802). Since the planetary gears move at the same speed as the carrier shaft, sidebands with the spacing of the carrier shaft speed around the planetary defect sidebands also serve as indicators of planetary gear faults (highlighted in lines 804).

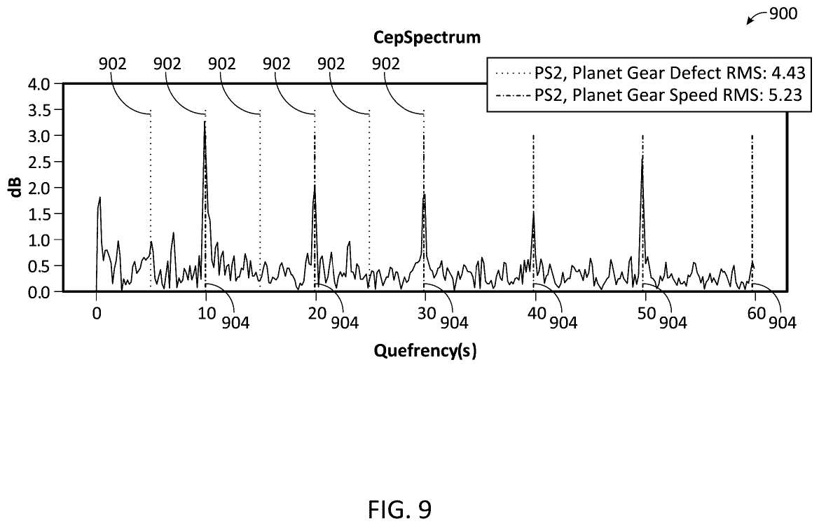

To prepare data for machine learning modeling, peak values, crest factor values, and/or RMS values may be derived (e.g., by the feature extraction module 606) from the relevant quefrency components and their rahmonics in the cepstrum. One or more of these features may be used to assist in identifying potential faults. FIG. 9 depicts the corresponding cepstrum 900 of the order spectrum depicted in FIG. 8, where the relevant quefrency components 902 and their rahmonics 904 are highlighted. Additionally, RMS values are shown as an illustration of one of the features that can be extracted from the cepstrum. The relevant quefrency components 902 in the cepstrum in FIG. 9 may correspond to the sidebands around the planetary tooth mesh frequency of lines 802 in FIG. 8. Further, the rahmonics 904 in the cepstrum in FIG. 9 may correspond to the sidebands with the spacing of the carrier shaft speed around the planetary defect sidebands of lines 804 in FIG. 8.

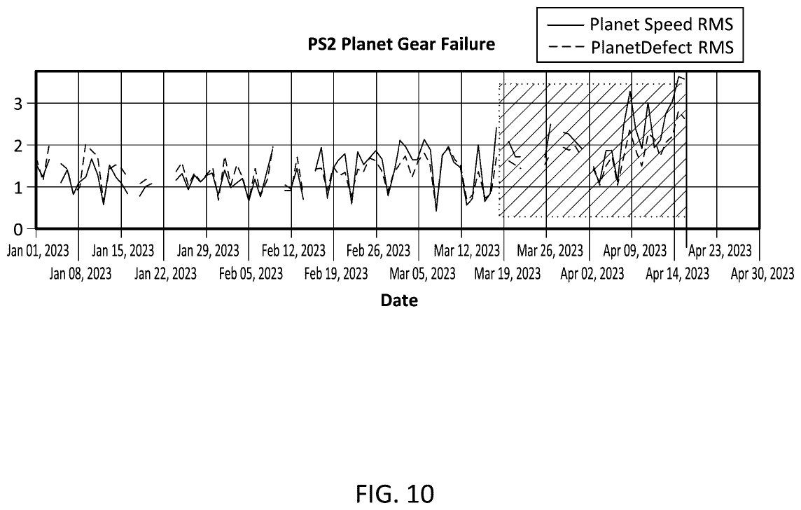

For turbines that experienced PS2 gear failures, features may be extracted over a specified duration prior to their breakdown. In one example, data up to 30 days before the failure event is captured to gather sufficient data to identify underlying failure patterns for PS2 gear defect. FIG. 10 depicts a subset of features extracted up to 30 days before failure in one example.

The window (e.g., time over which data is collected and analyzed) can be adjusted depending on how early the specific failure mode typically starts to progress. To create a comprehensive dataset for the binary classification problem, the same features may be extracted from data from turbines that did not experience PS2 failures, using them as healthy samples. In this example, training the dataset may include data from 119 turbines that failed in 2022 and 2023, sourced from various gearbox manufacturers, as well as data from over ten thousand healthy turbines from a 4-month period (October 2022-January 2023), representing normal operational conditions.

In this example, a logistic regression is used for simplicity, interpretability, and efficiency. In some embodiments, the logistic regression provides clear insights into feature importance and output probabilities, allowing for easy adjustment of decision thresholds to predict component failures accurately. As discussed herein, it will be appreciated that any ML system may be utilized (e.g., CNN, random forests, decision trees, and/or the like) or any combination of ML systems may be utilized.

In some embodiments, before feeding the data into the machine learning model, the features may be scaled by the processing module 608 according to the gearbox manufacturer and type to ensure consistency and accuracy.

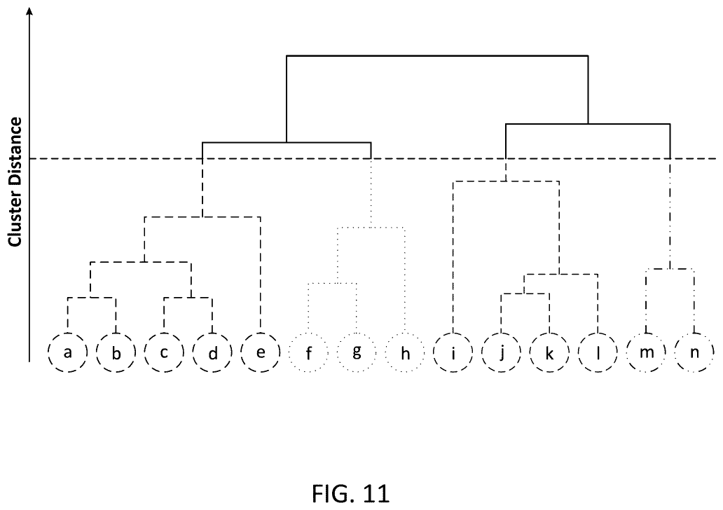

As discussed, in this example, a logistic regression model is used. In some embodiments, to enhance the logistic regression model's performance, hierarchical clustering and sklearn's SelectKBest method may be applied for feature pruning. In some embodiments, the feature extraction module 606 performs hierarchical clustering to remove features that are highly linearly correlated. In one example, the feature extraction module 606 calculates a correlation matrix of the features, converting it into a distance matrix D=1-abs (correlation), and performing clustering. By defining a threshold to form flat clusters, the feature extraction module 606 may select a representative feature from each cluster, thereby reducing redundancy. FIG. 11 depicts an example of hierarchical clustering in some embodiments.

Next, the feature extraction module 606 may use sklearn's SelectKBest method to identify the most important features by ranking the features based on their statistical significance and selecting the top K features that contribute most to the model's predictive power. This two-step feature selection process may be utilized to train the model on the more (or most) relevant and non-redundant features to further improve accuracy and generalizability.

During the training, the model validation module 618 may employ cross-validation (e.g., five-fold cross-validation) to evaluate the model's performance. In one example, this technique involves splitting the dataset into five equal-sized subsets. For each fold, the model validation module 618 may first perform the two-step feature selection process described above, and the logistic regression model is trained on four subsets (training set) and evaluated on the remaining subset (validation set). This process is repeated five times, with each subset being used exactly once as the validation data. For each validation set, the model validation module 618 may predict the probabilities of the positive class, which is the PS2 failure. By converting these probabilities to binary outcomes (0 or 1) across a range of thresholds from 0 to 1, the model validation module 618 may calculate performance metrics for each iteration based on the number of failure turbines which are correctly predicted. The performance metrics may optionally be averaged to provide a robust estimate of the model's accuracy and generalizability.

In some embodiments, a F-beta score may be used as the performance metric, as it is a weighted harmonic mean of precision and recall, which may emphasize precision and/or recall based on the value of beta. In one example, a beta value between 2 and 3 is utilized to prioritize recall, as capturing more potential PS2 failures may be more important for our application. In one example, the F-beta score is calculated as follows:

$${F}_{β} = ( 1 + {β}^{2} ) \cdot \frac{precision \cdot recall}{{β}^{2} \cdot precision + recall}$$

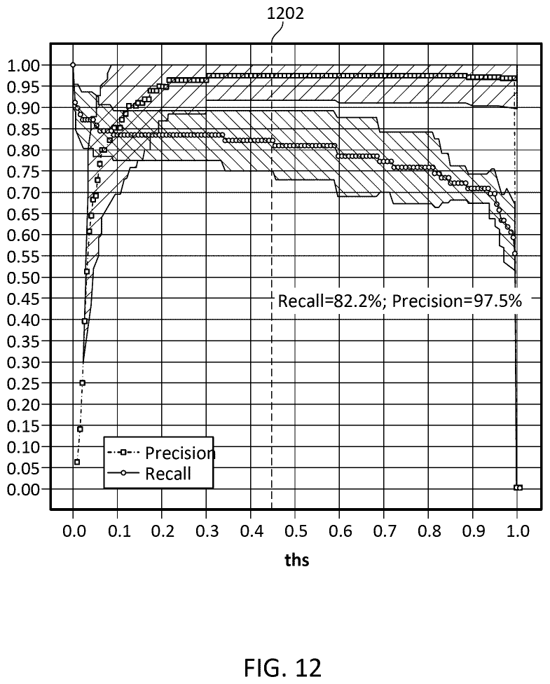

The performance assessment module 620 may analyze the recall and precision curves across different probability thresholds. This analysis assists to understand the trade-offs between precision and recall at various thresholds, ensuring that a chosen threshold aligns with the goal of maximizing recall without significantly compromising precision. FIG. 12 depicts a relationship between recall and precision across a range of thresholds in one example. In FIG. 12, the vertical line 1202 indicates a threshold where the F-beta score is maximized. In this case, the optimal threshold is 0.45, which yields a recall of 82.2% and a precision of 97.5%.

In this example, to validate the model's capability in detecting PS2 failures, data is collected from January to April 2024, including 16 failure turbines and 11,408 healthy turbines as the separate test set. The model demonstrated impressive performance on this dataset, achieving a 100% recall and an 87.5% precision. This means the model successfully identified all PS2 failure cases within the test duration without missing any while maintaining a low rate of false positives. Furthermore, the model provided an average lead time of 12 days for the predicted failures, demonstrating its potential to enable timely interventions and maintenance for Planetary Stage failures, given their fast-progressing nature.

Given its high test performance, this model can be deployed to predict Gearbox PS2 planet gear failures using operational data. This enables real-time monitoring, timely maintenance interventions, and reduced downtime for wind turbines susceptible to Planetary Stage failures.

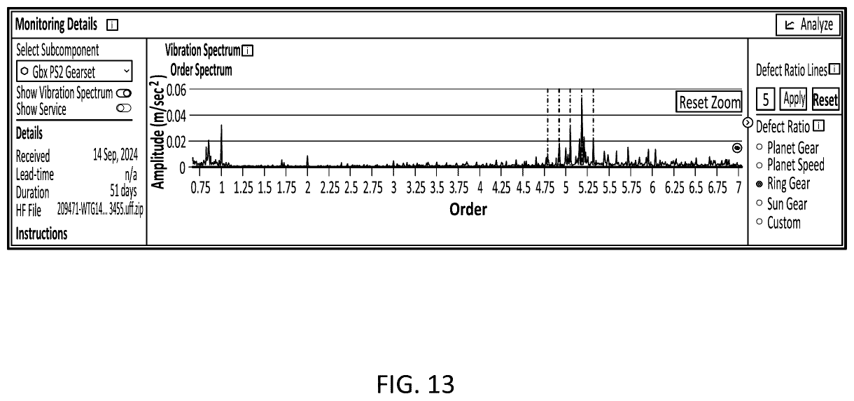

FIG. 13 is an example of a confirmed alert in an application from the PS2 gearset monitor using a process described herein. The turbine was first alerted for a ring gear defect on Gearbox PS2 on Sep. 14, 2024. An endoscopic inspection of the gearbox was performed on September 19, confirming broken and cracked teeth on the PS2 ring gear, as well as widespread marks

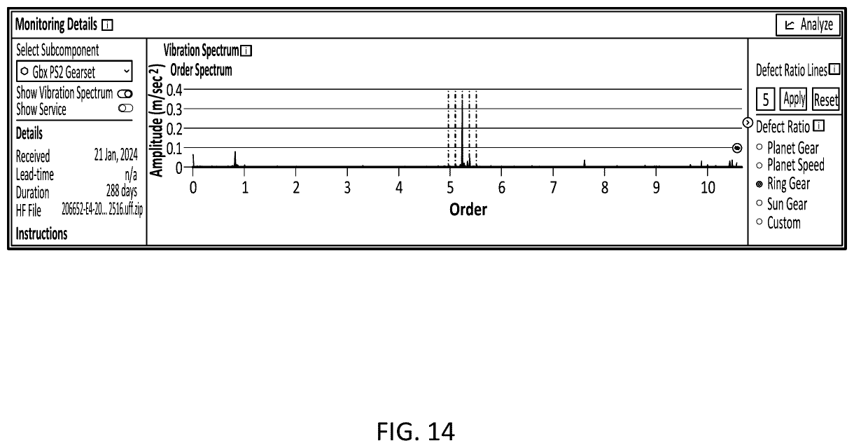

FIG. 14 is another example of a PS2 gearset failure detected by the monitor using a process described herein. In this example, the turbine was alerted on Jan. 21, 2024 at its very early failure stage. An endoscopic inspection of the gearbox was performed on February 7, confirming the micro-pitting and standstill marks on the PS2 ring gear.

FIG. 15 depicts a block diagram of an example computer system server 1500 according to some embodiments. Computer system server 1500 is shown in the form of a general-purpose computing device. Computer system server 1500 includes processor 1502, RAM 1504, communication interface 1506, input/output device 1508, storage 1510, and a system bus 1512 that couples various system components including storage 1510 to processor 1502.

System bus 1512 represents one or more of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system server 1500 typically includes a variety of computer system readable media. Such media may be any available media that is accessible by the failure prediction system 104, and it may include both volatile and nonvolatile media, as well as removable and non-removable media.

In some embodiments, processor 1502 is configured to execute executable instructions (e.g., programs). In some embodiments, the processor 1502 comprises circuitry or any processor capable of processing the executable instructions.

In some embodiments, RAM 1504 stores data. In various embodiments, working data is stored within RAM 1504. The data within RAM 1504 may be cleared or ultimately transferred to storage 1510.

In some embodiments, communication interface 1506 is coupled to a network via communication interface 1506. Such communication can occur via Input/Output (I/O) device 1508. Still yet, failure prediction system 104 may communicate with one or more networks such as a local area network (LAN), a general wide area network (WAN), and/or a public network (e.g., the Internet).

In some embodiments, input/output device 1508 is any device that inputs data (e.g., mouse, keyboard, stylus) or outputs data (e.g., speaker, display, virtual reality headset).

In some embodiments, storage 1510 can include computer system readable media in the form of volatile memory, such as read only memory (ROM) and/or cache memory. Storage 1510 may further include other removable/non-removable, volatile/non-volatile computer system storage media. By way of example only, storage 1510 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CDROM, DVD-ROM or other optical media can be provided. In such instances, each can be connected to system bus 1512 by one or more data media interfaces. As will be further depicted and described below, storage 1510 may include at least one program product having a set (e.g., at least one) of program modules that are configured to carry out the functions of embodiments of the invention. In some embodiments, RAM 1504 is found within storage 1510.

Program/utility, having a set (at least one) of program modules, such as failure prediction system 104, may be stored in storage 1510 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments of the invention as described herein.

It should be understood that although not shown, other hardware and/or software components could be used in conjunction with failure prediction system 104. Examples, include, but are not limited to: microcode, device drivers, redundant processing units, and external disk drive arrays, RAID systems, tape drives, and data archival storage systems, etc.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

As will be appreciated by one skilled in the art, aspects of one or more embodiments may be embodied as a system, method or computer program product. Accordingly, aspects may take the form of an entirely hardware embodiment, an entirely software embodiment (including firmware, resident software, micro-code, etc.), or an embodiment combining software and hardware aspects that may all generally be referred to herein as a “circuit,” “module” or “system.” Furthermore, aspects may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may be executed entirely on the user's computer, partly on the user's computer, as a standalone software package, partly on the user's computer, partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

1. A non-transitory computer-readable medium comprising executable instructions, the executable instructions being executable by one or more processors to perform a method, the method comprising:
receiving sensor measurements including time data from one or more wind turbines over time;
aligning time domain data of the sensor measurements of a particular wind turbine with a rotation speed of the particular wind turbine, the particular wind turbine being at least one of the one or more wind turbines;
transforming the aligned time domain data to obtain a cepstrum data;
identifying one or more quefrency components of the cepstrum data that correspond to periodicities of interest;
classifying at least one of the one or more quefrency components with future failure of at least one component of the particular wind turbine; and
providing an alert to a user based on the classification to alert the user of a predicted failure of the particular wind turbine.

2. The non-transitory computer-readable medium of claim 1, the method further comprising:
extracting a peak value of the one or more quefrency components, wherein classifying the at least one or more quefrency components of the cepstrum data that correspond to the periodicities of interest comprises classifying the peak value of the at least one or more quefrency components, the peak value corresponding to at least one periodicity of the periodicities of interest indicating a type of fault.

3. The non-transitory computer-readable medium of claim 1, the method further comprising:
extracting a root mean square (RMS) value calculated over a specific quefrency component of the one or more quefrency components and related rahmonics, wherein classifying the at least one or more quefrency components of the cepstrum data that correspond to the periodicities of interest comprises classifying the RMS value to quantify energy associated with at least some of the periodicities of interest, the quantified energy indicating a fault.

4. The non-transitory computer-readable medium of claim 1, the method further comprising:
extracting a peak value of the one or more quefrency components;
extracting a root mean square (RMS) value calculated over a specific quefrency component of the one or more quefrency components and related rahmonics; and
determining a crest factor by calculating a ratio of the peak value to the RMS value to identify impulsive events or irregularities in the cepstrum data indicating potential faults, wherein classifying the at least one or more quefrency components of the cepstrum data that correspond to the periodicities of interest comprises classifying the crest factor as an indicator of potential faults.

5. The non-transitory computer-readable medium of claim 1, wherein aligning the time domain data of the sensor measurements of the particular wind turbine with the rotation speed of the particular wind turbine comprises angular resampling of the sensor measurements to align the time domain data with the rotation speed of the particular wind turbine.

6. The non-transitory computer-readable medium of claim 1, wherein transforming the aligned time domain data to obtain cepstrum data comprises applying a Fourier transform to the aligned time domain data to generate transformed data and applying an inverse Fourier transform to the transformed data to generate the cepstrum data.

7. The non-transitory computer-readable medium of claim 6, the method further comprising determining a logarithm of a magnitude of a spectrum after application of the Fourier transform, the transformed data including the logarithm of the magnitude of the spectrum.

8. The non-transitory computer-readable medium of claim 1, wherein classifying the at least one of the one or more quefrency components with future failure of at least one component of the particular wind turbine comprises applying the one or more quefrency components of the cepstrum data that correspond to the periodicities of interest to a model, the model trained using logistic regression.

9. The non-transitory computer-readable medium of claim 8, wherein the model is validated using 5-fold cross validation to assess generalizability and reduce overfitting.

10. The non-transitory computer-readable medium of claim 9, wherein the model is validated in part by applying a probability threshold to classify a model prediction by the model, the probability threshold maximizing an F-beta score, the F-beta score being a weighted harmonic mean of precision and recall.

11. A failure prediction system, comprising
at least one processor; and
memory containing instructions, the instructions being executable by the at least one processor to:
receive sensor measurements including time data from one or more wind turbines over time;
align time domain data of the sensor measurements of a particular wind turbine with a rotation speed of the particular wind turbine, the particular wind turbine being at least one of the one or more wind turbines;
transform the aligned time domain data to obtain a cepstrum data;
identify one or more quefrency components of the cepstrum data that correspond to periodicities of interest;
classify at least one of the one or more quefrency components with future failure of at least one component of the particular wind turbine; and
provide an alert to a user based on the classification to alert the user of a predicted failure of the particular wind turbine.

12. The failure prediction system of claim 11, the instructions being further executable by the at least one processor to:
extract a peak value of the one or more quefrency components, wherein classifying the at least one or more quefrency components of the cepstrum data that correspond to the periodicities of interest comprises classifying the peak value of the at least one or more quefrency components, the peak value corresponding to at least one periodicity of the periodicities of interest indicating a type of fault.

13. The failure prediction system of claim 11, the instructions being further executable by the at least one processor to:
extract a root mean square (RMS) value calculated over a specific quefrency component of the one or more quefrency components and related rahmonics, wherein classifying the at least one or more quefrency components of the cepstrum data that correspond to the periodicities of interest comprises classifying the RMS value to quantify energy associated with at least some of the periodicities of interest, the quantified energy indicating a fault.

14. The failure prediction system of claim 11, the instructions being further executable by the at least one processor to:
extract a peak value of the one or more quefrency components;
extract a root mean square (RMS) value calculated over a specific quefrency component of the one or more quefrency components and related rahmonics; and
determine a crest factor by calculating a ratio of the peak value to the RMS value to identify impulsive events or irregularities in the cepstrum data indicating potential faults, wherein classifying the at least one or more quefrency components of the cepstrum data that correspond to the periodicities of interest comprises classifying the crest factor as an indicator of potential faults.

15. The failure prediction system of claim 11, wherein the instructions being executable by the at least one processor to align the time domain data of the sensor measurements of the particular wind turbine with the rotation speed of the particular wind turbine comprises the instructions being further executable by the at least one processor to angular resample the sensor measurements to align the time domain data with the rotation speed of the particular wind turbine.

16. The failure prediction system of claim 11, wherein the instructions being executable by the at least one processor to transform the aligned time domain data to obtain cepstrum data comprises the instructions being further executable by the at least one processor to apply a Fourier transform to the aligned time domain data to generate transformed data and apply an inverse Fourier transform to the transformed data to generate the cepstrum data.

17. The failure prediction system of claim 16, wherein the instructions are further executable by the at least one processor to further determine a logarithm of a magnitude of a spectrum after application of the Fourier transform, the transformed data including the logarithm of the magnitude of the spectrum.

18. The failure prediction system of claim 11, wherein the instructions being executable by the at least one processor to classify the at least one of the one or more quefrency components with future failure of at least one component of the particular wind turbine comprises the instructions being further executable by the at least one processor to apply the one or more quefrency components of the cepstrum data that correspond to the periodicities of interest to a model, the model trained using logistic regression.

19. The failure prediction system of claim 18, wherein the model is validated using 5-fold cross validation to assess generalizability and reduce overfitting.

20. The failure prediction system of claim 18, wherein the model is validated in part by applying a probability threshold to classify a model prediction by the model, the probability threshold maximizing a F-beta score, the F-beta score being a weighted harmonic mean of precision and recall.

21. A method comprising:
receiving sensor measurements including time data from one or more wind turbines over time;
aligning time domain data of the sensor measurements of a particular wind turbine with a rotation speed of the particular wind turbine, the particular wind turbine being at least one of the one or more wind turbines;
transforming the aligned time domain data to obtain a cepstrum data;
identifying one or more quefrency components of the cepstrum data that correspond to periodicities of interest;
classifying at least one of the one or more quefrency components with future failure of at least one component of the particular wind turbine; and
providing an alert to a user based on the classification to alert the user of a predicted failure of the particular wind turbine.
